(19) United States
(12) Patent Application Publication
(10) Pub. No.: US 2013/0132212 A1
(43) Pub. Date: May 23, 2013

(54) REAL-TIME DYNAMIC PAGE AWARENESS FOR AD SERVING

(71) Applicants: Fernando Ruarte, San Francisco, CA (US); Samir Arora, Woodside, CA (US); Arthur Schram, Davis, CA (US); Jamie Maddaloni, San Francisco, CA (US); Bryan Beresford, Redwood City, CA (US); Lindsey Frankenfield, Oakland, CA (US); Anne Farmer, Oakland, CA (US); Bao-Long Nguyen-Trong, Alameda, CA (US); Abhijeet Shah, Pune (IN); Ashok Srinivas, Pune (IN); Darshana Munde, Pune (IN)

(72) Inventors: Fernando Ruarte, San Francisco, CA (US); Samir Arora, Woodside, CA (US); Arthur Schram, Davis, CA (US); Jamie Maddaloni, San Francisco, CA (US); Bryan Beresford, Redwood City, CA (US); Lindsey Frankenfield, Oakland, CA (US); Anne Farmer, Oakland, CA (US); Bao-Long Nguyen-Trong, Alameda, CA (US); Abhijeet Shah, Pune (IN); Ashok Srinivas, Pune (IN); Darshana Munde, Pune (IN)

(21) Appl. No.: 13/483,509

(22) Filed: May 30, 2012

Related U.S. Application Data
(60) Provisional application No. 61/493,225, filed on Jun. 3, 2011.

(51) Int. Cl. G06Q 30/02

(52) U.S. Cl. CPC G06Q 30/0277
USPC 705/14.73

(57) ABSTRACT

An ad serving platform utilizes real time dynamic page awareness for ad serving. For every new digital content URL, the ad serving platform reviews the layout and relative position of ad placements in a content environment and stores a “map” of this information, which is accessible to the ad server in real time for use in ad selection, and is refreshed periodically (e.g., every three minutes) to account for changes. As a result, without control of the page, the ad server platform can make complex serving decisions based upon relative page position of advertising placements.

### PRIORITY CLAIM

This application claims the benefit of U.S. Provisional Application No. 61/493,225, filed on Jun. 3, 2011, by Ruarte et al. and titled “Real-Time Dynamic Page Awareness for Ad Serving. Provisional Application No. 61/493,225 is hereby incorporated by reference herein in its entirety.

### FIELD OF THE INVENTION

The present invention relates to the on-line display of advertising and, in particular, to systems and methods for making complex ad serving decisions based upon relative page position of advertising placements without control of the page.

### BACKGROUND OF THE INVENTION

Digital content pages (such as Website URLs) have distinct layouts. These layouts define all things on the page, not the least of which is the relative position of all of the advertising placements on the page.

Ad servers, when delivering digital advertising content to these placements, may need to understand information on relative page position in the decisions they make to serve specific types of ads. For example, if an advertising execution brings with it the requirement of two ads of different size serving adjacent to one another, then the ads must be targeted to placements which the ad server knows confidently are adjacent to one another.

In most ad serving systems, this problem is addressed through taxonomy. For example, an ad serving tag may be given the unique attribute of “above the fold” meaning that it will appear in the visible portion of the page when the Website loads. This tag that has been defined as “above the fold” will then be placed in an above the fold placement on the Website page by the page owner. If an ad is targeted to be above the fold, it will be eligible to serve only in tags that have been given this specific attribute. However, the process is dependent on the user managing the layout of the page, and by extension, knowing that their “above the fold” tag was placed in the correct above the fold position.

It is, however, often the case that the entity delivering the advertising is not the same as the entity controlling the page layout (for example because the owner of the digital content creator has contracted with a company specializing in advertising to sell and serve ads to their content). In this case, a reliance on a taxonomy-driven notion of page layout is much less viable since there can be dozens of possible layout combinations and there is no guarantee that a set of taxonomy elements has been appropriately applied in all cases.

### SUMMARY OF THE INVENTION

Embodiments of an ad serving platform in accordance with the concepts of the present invention take a radically different approach to understanding page layout and the relative position of ad placements in a content environment. For every new digital content URL, the ad serving platform reviews the layout and relative position of ad placements in a content environment and stores a ‘map’ of this information, which is accessible to the ad server in real time for use in ad selection, and is refreshed periodically (e.g., every three minutes) to account for changes. As a result, without control of the page, the ad server platform can make complex serving decisions based upon relative page position of advertising placements.

The features and advantages of the various aspects of the subject matter disclosed herein will be more fully understood and appreciated upon consideration of the following detailed description and accompanying drawings, which set forth illustrative embodiments in which the concepts of the claimed subject matter are utilized.

### BRIEF DESCRIPTION OF THE DRAWINGS

FIG. 1 shows screenshots illustrating the conceptual flow of page information setting.

FIG. 2 is a diagram of calls illustrating how page information is set.

FIG. 3 is a diagram illustrating use of data for ad selection.

### DETAILED DESCRIPTION

Embodiments of an ad serving platform in accordance with the concepts of the present invention take a radically different approach to understanding page layout and the relative position of ad placements in a content environment. For every new digital content URL, the ad serving platform reviews the layout and relative position of the ad placements, and stores a “map” of this information, which is accessible to the ad server in real time for use in ad selection, and is refreshed every 3 minutes to account for changes. As a result, without control of the page, the ad serving platform can make complex ad serving decisions based on relative page position of advertising placements.

At a technical level, the ad serving platform gives each digital content page (i.e. the Website URL) a unique identifier. Each time it sees a new URL, the system creates an entry for that URL and stores the attributes that it can recognize, which include (but are not limited to):

Number of placements

Placement size

Relative order of placements

Relative x/y pixel coordinates of placements

Relative position of placements as it relates to the page “fold”.

The data remains unchanged for a period of time, e.g., 3 minutes, at which point the system will wait for the next time the URL is seen and update the data with the information from the latest request. The ad serving platform's targeting then enables targeting against these attributes for ads.

The disclosed embodiment of the invention can be broken into three components:

Reading page information.

Setting page information in memory and refreshing it.

Reading the stored data by the ad server for ad targeting.

Reading the page information and calculating coordinates:

The ad serving platform's javascript tags contain code that reads the page position by x/y pixel coordinates of the ad placement making the ad request. The fold of the page is defined as 1000 pixels from the top of the page, and relative position is calculated accordingly.

Setting the page information and refreshing it:

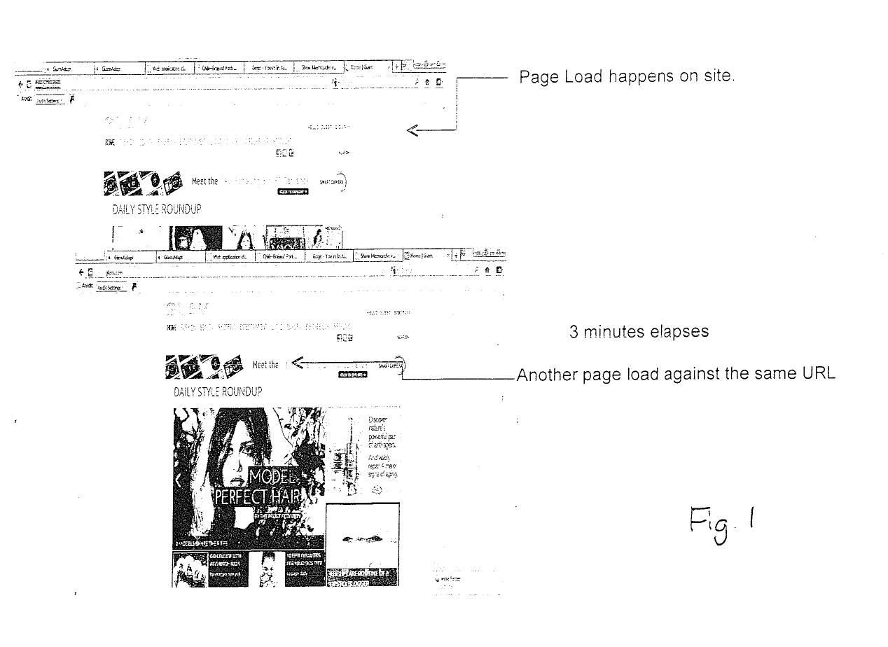

FIG. 1 outlines the setting and data refresh process: In the FIG. 1 diagram, a new Website URL is recording page parameters and setting them in memcache, a process which is periodically repeated for each URL, e.g., every approximately 3 minutes, or until the unique URL is seen again. More specifically, in the information setting conceptual flow shown in FIG. 1, a page load happens on site. The ad server of the ad serving platform then receives a call, based upon the configuration of the ads (specific unit sizes in specific positions) against the key of a specific page URL. Information against the specific page level call is read and stored in memcache, including each specific size of the page and their relative X/Y coordinate position to each other. A period time (e.g., three minutes) then elapses before there is another page load against the same URL. The ad server again receives a call, with the same set of parameters, based upon the configuration of the site at the time. Once again, the data is gathered and stored in memcache against the same URL key.

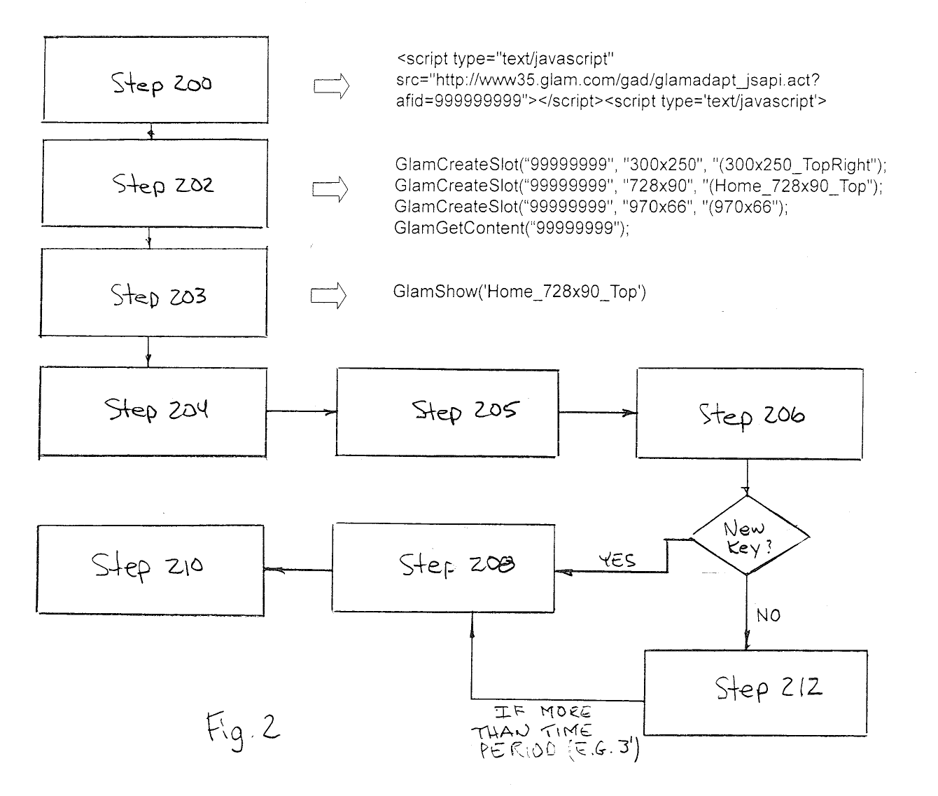

FIG. 2 provides an embodiment of a diagram of calls showing how the page information is set. According to the FIG. 2 embodiment, the ad serving platform receives a javascript call (from a javascript tag placed on the site source code). (Step 200). Parameters placed on the site code define ad size calls. (Step 202). Positions of ads on the page are then defined by placement of specific ad size “slots” in the page layout. (Step 203). The call reaches the ad server platform, passing sizes as parameters. (Step 204). Ad server platform javascript code dynamically reads X/Y coordinates of ad size calls. (Step 205). A match is then made to a “URL Key” (an MD5 hash of the URL) assigned dynamically to every URL the ad serving platform sees. (Step 206). As shown in the FIG. 2 flow, if the URL Key is new, the system creates a “set” of information in a memcache server within the datacenter that the call is made to. (Step 208). The data is then replicated replicated across all memcache servers across all ad server platform datacenters. (Step 210) As further shown in the FIG. 2 flow, if the URL Key is not new, then the ad server system checks the last time that information was updated for the URL Key (Step 212). If more than a designated period of time has elapsed (e.g., three minutes), then the system does a set of information in a memcache server within a the datacenter that the call is made to (Step 208) and the data is replicated across all memcache servers across all ad server platform datacenters.

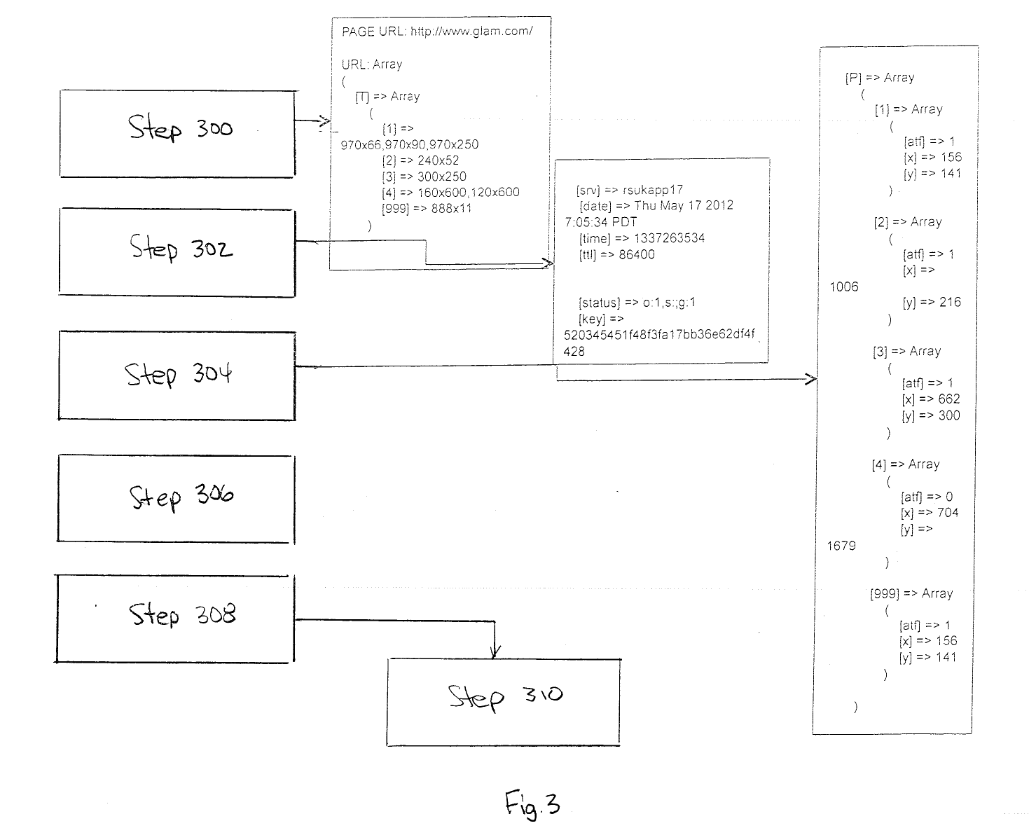

FIG. 3 shows an embodiment of the use of data for ad selection in accordance with the concepts of the invention. As shown in FIG. 3, sizes on the page are stored in an array, based upon the process outlined above in conjunction with FIG. 1. (Step 300). URL Keys are listed relative to the ad server the information is updated from, and when. (Step 302). X/Y coordinates are listed in an array, relative to each size call. (Step 304). The ad serving platform includes targeting language that allows for the creation of expressions against the data. (Step 306).

Targeting syntax is entered into ad targeting screens of the ad server of the ad serving platform. (Step 308). Ads are delivered according to targeting, enabling dynamic page-level understanding of layout across all URLs. (Step 310).

The FIG. 3 page data array shows not only both the ad placement sizes on the page and their relative order, but also the above the fold and x/y coordinate parameters of each defined ad placement.

Reading the stored data by the ad server for ad targeting:

The ad serving platform's targeting engine allows for the creation of targeting expressions that are used to match ads to pages and their respective ad placements in real time. The following are examples of these targeting expressions:

page.ads.728×90.1.tile<page.ads.160×600.1.tile

Translated, this means: “The 728×90 ad placement on the page is directly adjacent to the 160×600 placement, and the 728×90 must come first.”
page.adsizes˜970×66
Translated this means: “The page must contain ad sizes 970×66”.

By recording a dynamic page map, outlining critical page position data about ad placements on digital content pages, the ad serving platform can make intelligent ad serving decisions, specifically centered on the ability to deliver ads that have very defined page position requirements. It can do this at scale across many non-standard digital content environments, without the need for extensive and unreliable ad tag taxonomy management.

It should be understood that the particular embodiments of the invention described herein have been provided by way of example and that other modifications may occur to those skilled in the art without departing from the scope of claimed subject as expressed in the appended claims and their equivalents.

What is claimed is:

1. A computer-implemented method of setting page information, the method comprising:
utilizing an ad serving platform to receive ad calls;
defining the size of the ad calls utilizing parameters place on onsite code;
defining the position of ads on a page by placing specific ad size slots in the page layout;
utilizing the ad serving platform to receive ad calls that pass ad sizes as parameters;
utilizing the ad serving platform to dynamically read X/Y coordinates of ad size calls;
making a match to a URL key assigned dynamically to URLs received by the ad serving platform;
in the event that the match identifies a new URL key, utilizing the ad serving platform to create a set of information and store the set of information in a memory system; and
in the event that the match does not identify a new URL key, utilizing the ad serving platform to check the last time information for the URL key has been updated;
in the event that more than a specified time period has elapsed since the last time information for the URL key has been updated, utilizing the ad serving platform to create a set of information and storing the set of information in a memory system.
